(19) United States
(12) Patent Application Publication
(10) Pub. No.: US 2019/0070968 A1
(43) Pub. Date: Mar. 7, 2019

(54) VEHICLE CHARGING SYSTEM, PARKING LOT SYSTEM, AND METHOD FOR CHARGING VEHICLE

(71) Applicant: NEC Corporation, Tokyo (JP)

(72) Inventors: Yuichiro FUKUBAYASHI, Tokyo (JP); Yasuaki KONDO, Tokyo (JP)

(73) Assignee: NEC Corporation, Tokyo (JP)

(21) Appl. No.: 16/082,149

(22) PCT Filed: Mar. 8, 2017
(86) PCT No.: PCT/JP2017/009274

§ 371 Date: Sep. 4, 2018

(30) Foreign Application Priority Data
Mar. 9, 2016 (JP) 2016-046030

(51) Int. Cl. B60L 11/18; H02J 7/02; H02J 50/12; H02J 50/90

(52) U.S. Cl. CPC B60L 11/1829; B60L 11/182; B60L 11/1846; H02J 7/025; B60K 6/22; H02J 50/90; B60L 2230/14; B60Y 2200/91; B60Y 2200/92; H02J 50/12

(57) ABSTRACT

A vehicle charging system comprises: a non-contact type charging apparatus that charges a battery of a vehicle in a non-contact state by facing a power-receiving coil mounted on the vehicle; and a charging controller that sequentially perform charging of vehicles stopping aligned in a first direction by changing relative position between the vehicles and the charging apparatus along the first direction.

### DESCRIPTION OF RELATED APPLICATION

This application is a national stage application of International Application No. PCT/JP2017/009274 entitled “Vehicle-Charging System, Parking Lot System, and Method for Charging Vehicle,” filed on Mar. 8, 2017, which claims priority to Japanese Patent Application No. 2016-046030 filed on Mar. 9, 2016, the disclosures of which are hereby incorporated by reference in their entirety.

### FIELD

The present invention relates to a vehicle charging system, a parking lot system and a method for charging vehicle, and more particularly to a vehicle charging system, a parking lot system and a method for charging vehicle that charges a battery mounted on a vehicle in a non-contact state.

### BACKGROUND

In recent years, a method for charging batteries mounted on vehicles in the non-contact state has been studied. For example, Patent Literature 1 discloses an example of a charging system in which a secondary battery mounted on a vehicle can be charged during parking. According to Patent Literature 1, this charging system 101 has a configuration that comprises: a vehicle parking base 110 which is movable with a vehicle mounted thereon; a first high-frequency wireless power-transmitting apparatus 120 installed in the vehicle parking base 110; a second high-frequency wireless power-transmitting apparatus 150 installed in a parking lot structure; a relative position determination part 160 for determining whether or not the first high-frequency wireless power-transmitting apparatus 120 and the second high-frequency wireless power-transmitting apparatus 150 are in a predetermined positional relationship, wherein if it is determined by the relative position determination part 160 that they are in the predetermined positional relationship, wireless power-transmitting is performed from the second high-frequency wireless power-transmitting apparatus 150 to the first high-frequency wireless power-transmitting apparatus 120.

Patent Literature 2 discloses a technique relating to positioning of a power-receiving side coil and a power-transmitting side coil in non-contact type charging. According to Patent Literature 2, this charging system comprises a position adjusting part 27 that adjusts a position of a power-transmitting side coil 21 so that a positional relationship is achieved in which a power-receiving side coil 20 and the power-transmitting side coil 21 are electromagnetically coupled to each other, and the power-receiving side coil 20 is provided on a protrusion 11 on a side surface of a vehicle 10 and comprises a gap sensor 22 for measuring a distance between the power-transmitting side coil 21 and, the side surface of the vehicle 10 and the protrusion on the power-transmitting side coil 21 side, and the position adjustment unit 27 adjusts a position of the power-transmitting side coil 21 so that the difference in the measurement result of the gap sensor 22 is within a predetermined range,

Patent Literature 3 discloses a configuration in which a power-transmitting coil is placed in a traveling path of a vehicle so that it can be charged during running.

### [Patent Literature 1]

JP patent Kokai Publication No. JP2013-110877A

### [Patent Literature 2]

JP patent Kokai Publication No. JP2011-36107A

### [Patent Literature 3]

JP patent Kokai Publication No. JP2014-236539A

### SUMMARY

The following analysis is given by the present invention. In order to charge a plurality of vehicles also in the non-contact type charging system, it is necessary to prepare a large number of power-transmitting side coils (charging facilities) as shown in the configuration of Patent Literature 1. For this reason, the method of Patent Literature 1 has a problem of high cost.

On the other hand, in a configuration in which sequentially charges using one charging facility, since a movement of a vehicle is left to a driver, a stopping position of the vehicle may vary. Also, the position of the power-receiving side coil may be different depending on the vehicle. For these reasons, in this configuration, it is indispensable to align the power-transmitting side coil and the power-receiving side coil. Patent Literature 2 adopts a configuration that uses at least three gap sensors to adjust the positional relationship between the power-transmitting side coil and the power-receiving side coil. However, in this method, it is necessary to adjust the position of the power-transmitting side coil based on the three gap sensors and the measurement results thereof, and there is a problem that cost is increased.

It is an object of the present invention to provide a vehicle charging system, a parking lot system and a method for charging vehicle which can contribute to cost reduction of a charging system capable of charging the plurality of vehicles.

According to a first aspect, there is provided a vehicle charging system comprising a non-contact type charging apparatus that charges a battery of a vehicle in a non-contact state by facing a power-receiving coil mounted on the vehicle. The vehicle charging system further comprises a charging controller configured to sequentially perform charging of vehicles that are stopping aligned in a first direction by changing a relative position between the vehicle and the charging apparatus along the first directions to the vehicles that are stopping at any one of a plurality of sections aligned in the first direction.

According to a second aspect of the present invention, there is provided a parking lot system, comprising: a non-contact type charging apparatus that performs charging of a battery of a vehicle in a non-contact state; a pallet arranged along a first direction and loading at least one vehicle; a pallet driving apparatus configured to move the pallet in the first direction; and a charging controller configured to change a relative position between a plurality of vehicles and the charging apparatus and to perform sequential charging of the plurality of vehicles by controlling the pallet driving apparatus, the plurality of vehicles stopping aligned in the first direction.

According to a third aspect, there is provided a method for charging vehicle(s), wherein a non-contact type charging apparatus charges a battery of a vehicle in a non-contact state by facing a power-receiving coil mounted on the vehicle, and a charging controller capable of charging a relative position between a non-contact type charging apparatus and the vehicles: and performs the followings:

charging to a first vehicle stopping at any one of a plurality of sections aligned in a first direction; and
charging a second vehicle by facing the second vehicle stopping at another one of the plurality of sections and the charging apparatus each other by changing a relative position between the charging apparatus and the vehicle after charging the first vehicle. This method is tied to a specific machine called as a vehicle charging system that charges a plurality of vehicles in a non-contact state.

The meritorious effects of the present invention are summarized as follows.

According to the present invention, installing cost of a charging system capable of charging a plurality of vehicles can be reduced. Namely, the present invention can transform a charging system into a charging system that can reduce installing cost of a charging system capable of charging a plurality of vehicles using a non-contact charging apparatus.

### BRIEF DESCRIPTION OF THE DRAWINGS

FIG. 1 is a diagram showing a configuration of an exemplary embodiment of the present disclosure.

FIG. 2 is a diagram showing a modified configuration of an exemplary embodiment of the present disclosure.

FIG. 3 is a diagram showing a configuration of a vehicle charging system according to a first exemplary embodiment of the present disclosure.

FIG. 4 is a diagram for explaining an operation of the vehicle charging system according to the first exemplary embodiment of the present disclosure.

FIG. 5 is a diagram for explaining the operation of the vehicle charging system according to the first exemplary embodiment of the present disclosure.

FIG. 6 is a diagram for explaining the operation of the vehicle charging system according to the first exemplary embodiment of the present disclosure.

FIG. 7 is a diagram for explaining the operation of the vehicle charging system according to the first exemplary embodiment of the present disclosure.

FIG. 8 is a diagram showing a configuration of a vehicle charging system according to a second exemplary embodiment of the present disclosure.

FIG. 9 is a diagram for explaining an operation of the vehicle charging system according to the second exemplary embodiment of the present disclosure.

FIG. 10 is a diagram for explaining the operation of the vehicle charging system according to the second exemplary embodiment of the present disclosure.

FIG. 11 is a diagram for explaining the operation of the vehicle charging system according to the second exemplary embodiment of the present disclosure.

FIG. 12 is a diagram showing a configuration of a vehicle charging system according to a third exemplary embodiment of the present disclosure.

FIG. 13 is a diagram showing a configuration of a vehicle charging system according to a fourth exemplary embodiment of the present disclosure.

FIG. 14 is a diagram showing an example of vehicle information held by the vehicle charging system according to a fourth exemplary embodiment of the present disclosure.

FIG. 15 is a diagram for explaining an operation of the vehicle charging system according to the fourth exemplary embodiment of the present disclosure.

FIG. 16 is a diagram showing a configuration of a vehicle charging system according to a fifth exemplary embodiment of the present disclosure.

FIG. 17 is a diagram for explaining an operation of the vehicle charging system according to the fifth exemplary embodiment of the present disclosure.

FIG. 18 is a diagram showing a configuration of a vehicle charging system according to a sixth exemplary embodiment of the present disclosure.

FIG. 19 is a diagram showing a configuration of a parking lot system according to a seventh exemplary embodiment of the present disclosure.

FIG. 20 is a diagram showing a configuration of a vehicle charging system according to an eighth exemplary embodiment of the present disclosure.

### PREFERRED MODES

First, an overview of one exemplary embodiment of the present disclosure will be described with reference to the drawings. It is to be noted that reference numerals indicated in the drawings and attached to this overview are attached to each element for convenience as an example for aiding understanding and are not intended to limit the present disclosure to the illustrated mode. Also, the connecting lines between blocks in the drawings used in the following explanation include both bidirectional and unidirectional connection lines. The one-way arrow schematically shows the flow of the main signal (data), and does not exclude bidirectionality.

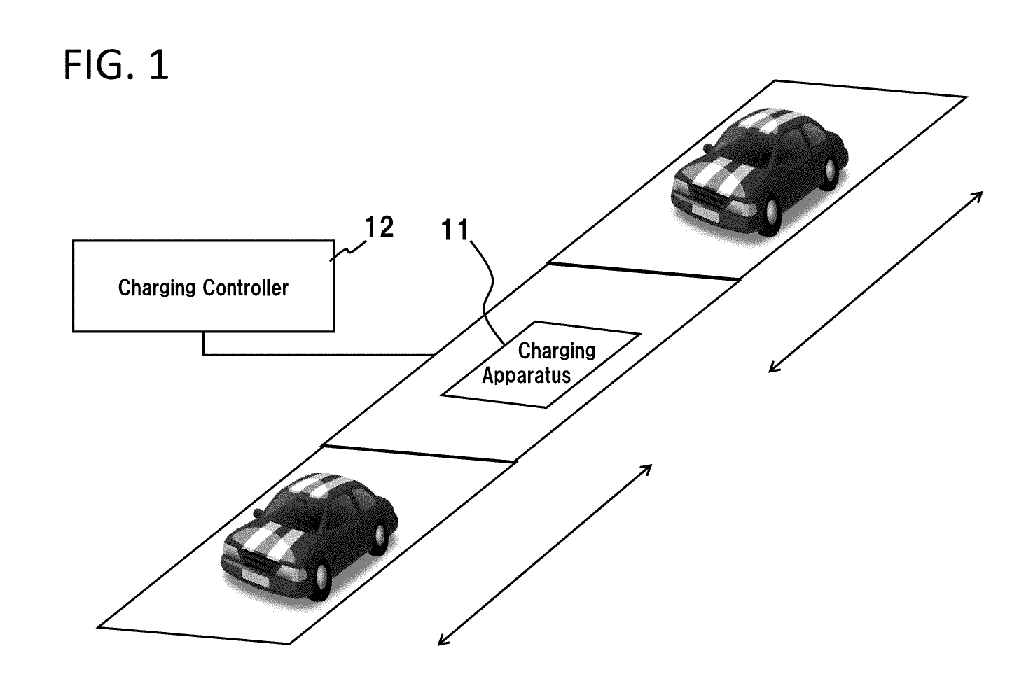

The present disclosure, in one exemplary embodiment thereof, as shown in FIG. 1, can be realized by a vehicle charging system comprising: a non-contact type charging apparatus 11 charging a battery of a vehicle in a non-contact state by facing a power-receiving coil mounted on the vehicle; and a charging controller 12.

More specifically, the charging controller 12 sequentially charges vehicle(s) that is(are) stopping aligned in a first direction by changing a relative position between the vehicle and the charging apparatus 11 along the first direction to the vehicle(s) that is stopping at any one of a plurality of sections arranged in a first direction (for example, a direction parallel to the arrow line in FIG. 1). As methods for changing the relative position between the vehicle and the charging apparatus 11, it is possible to adopt a method of moving either the vehicle(s) or the charging apparatus 11, or a method of moving both the vehicle(s) and the charging apparatus 11. In the following explanation, it will be described on the premise that the charging controller 12 comprises a vehicle moving part configured to move the vehicle to face the vehicle and the charging apparatus 11 each other.

For example, the charging controller 12 first moves a pallet mounting a vehicle shown at the lower left of FIG. 1 and moves it just above the charging apparatus 11. As a result, a power-receiving coil of the vehicle of the lower left of FIG. 1 and a power-transmitting coil of the charging apparatus 11 can charge by approaching each other (making them electromagnetically coupled). After completing the charging of the vehicle of the lower left of FIG. 1, the charge controller 12 returns the pallet of the lower left in FIG. 1 on which the vehicle is mounted to original position and moves the pallet of the upper right of FIG. 1 on which the vehicle is mounted just above the charging apparatus 11. As a result, the power-receiving coil of the vehicle of the upper right of FIG. 1 and the power-transmitting coil of the charging apparatus 11 can charge by approaching each other (making them electromagnetically coupled).

By doing as described above, it is possible to charge a plurality of vehicles by one charging apparatus 11. Also, the positioning with the charging apparatus 11 which is required at that time is performed simultaneously with the change of the vehicle to be charged. For this reason, at least as for the first direction, the charging apparatus 11 does not need to have a position adjusting function, and thus cost reduction can be achieved.

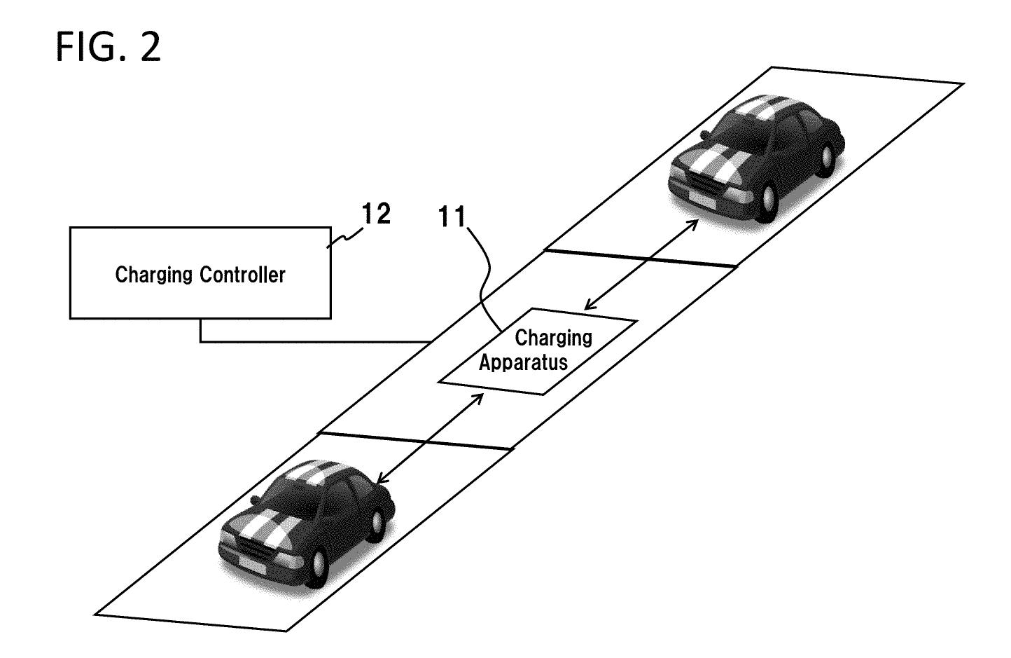

In the example of FIG. 1, although it is described on the premise that the power-receiving coil of the vehicle and the charging apparatus 11 are aligned by moving the pallet on which the vehicle is mounted, as shown in FIG. 2, it is also possible to adopt a configuration that the charging apparatus 11 is moved. However, in the case of the configuration shown in FIG. 2, constraints may occur by the length, weight, etc. of the cable in order to supply electric power to the power-transmitting coil of the charging apparatus 11, and thus when charging a large number of vehicles, it is possible to be said that the configuration of FIG. 1 is preferable.

Also, in the examples of FIGS. 1 and 2, although it is described on the premise that the pallet on which the vehicle is mounted or the charging apparatus 11 is moved reciprocated by the pallet or the charging apparatus 11 may be sequentially moved in a direction in which the vehicles are lined up. For example, it is also possible to adopt a configuration in which a plurality of vehicles is sequentially charged by successively moving pallets so that one end of the first direction is set as a start point of the charge queue and the other end is set as an end point of the charge queue,

### First Exemplary Embodiment

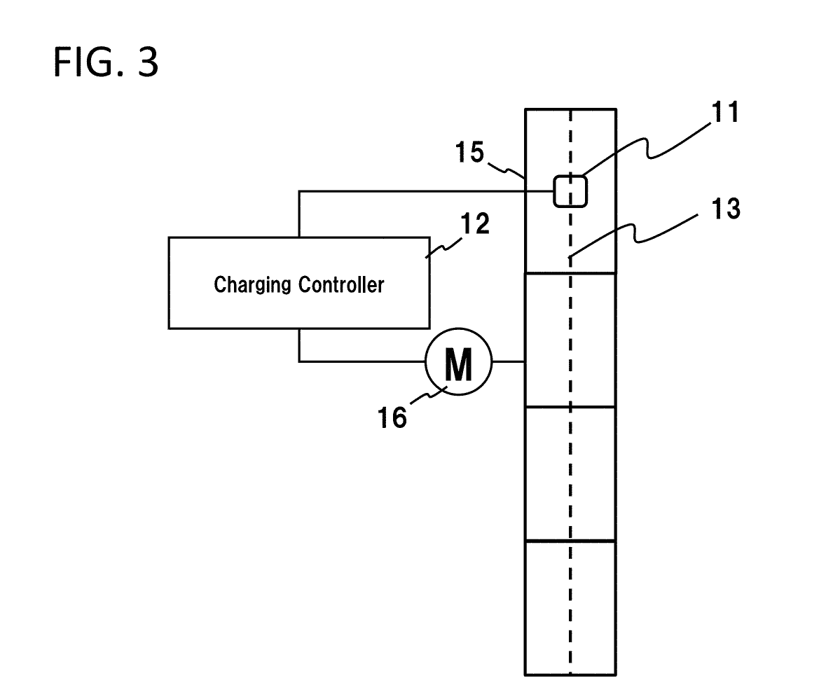

Subsequently, a first exemplary embodiment of the present disclosure will be described in detail with reference to drawings. FIG. 3 is a diagram showing a configuration of a vehicle charging system according to the first exemplary embodiment of the present disclosure. Referring to FIG. 3, there is shown a configuration in which the charging apparatus 11 arranged under a pallet 15 and the charging controller 12 are connected.

The charging apparatus 11 is a non-contact type charging apparatus that charges the battery of the vehicle in a non-contact state by facing the power-receiving coil (charging port) 14 mounted on the vehicle. The method of non-contact type charging is not particularly limited, and it may be any of electromagnetic inducting method and resonance method, for example. In the case of the resonance method, power-transmitting from the power-transmitting coil in the charging apparatus 11 to the power-receiving coil 14 is performed by coupling vibration (resonance) between the circuit of the power-transmitting coil side and the circuit of the power-receiving coil 14 side. More specifically, in the power-transmitting coil side, for example, a resonance circuit of the power-transmitting side is formed together with a capacitor, and in the power-receiving coil 14 side, a resonance circuit of the power-receiving side is formed together with the capacitor. The resonance frequency of the power-transmitting side and the power-receiving side are set to the same frequency and the resonance circuit of the power-transmitting side and the resonance circuit of the power-receiving side are coupled resonance at the frequency. As a result, electric power can be transmitted from the charging apparatus 11 to the vehicle side without making the power-transmitting coil and the power-receiving coil 14 mechanically contact.

The charging controller 12 drives a pallet moving part 16 configured by a motor or the like to make the power-receiving coil of the vehicles 20a to 20c and the power-transmitting coil of the charging apparatus 11 electromagnetically coupled. Also, the charging controller 12 controls the charging operation by transmitting a charging start signal or a charging end signal to the charging apparatus 11.

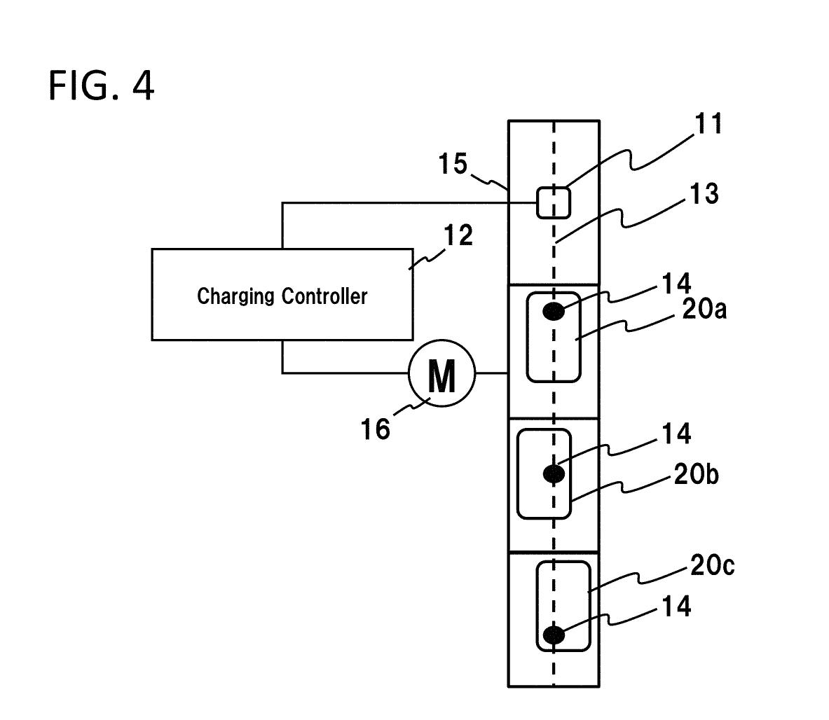

The broken line extending in a top-bottom direction (first direction) in FIG. 3 is a reference line 13 for parking guidance shown to the drivers of the vehicles 20a to 20c shown in FIG. 4. While viewing the reference line 13, the drivers of the vehicles 20a to 20c park so that the power-receiving coil of the vehicle is positioned on the reference line 13. By doing so, it is possible to configure a train so that the power-receiving coils of the vehicles 20a to 20c and the power-transmitting coil of the charging apparatus 11 are aligned in one straight line by merely moving the pallet 15. That is, the reference line 13 functions as a guiding part configured to guide a stop position on a straight line on which the power-receiving coil 14 and the charging apparatus 11 can face each other by moving either one of the power-receiving coil 14 and the charging apparatus 11.

The reference line 13 can be realized by drawing on the palette 15 with paint or the like. Also, instead of the method using such a paint, the reference line can also be configured by irradiating laser light or the like on the pallet 15. Further, in the examples of FIGS. 3 and 4, although the reference line is drawn with one broken line, it may be a solid line, or an additional auxiliary line may be drawn in addition to the broken line. Furthermore, a line indicating a stop position along a front-rear direction of the vehicle (up and down direction in FIGS. 3 and 4) may be added.

The vehicles 20a to 20c of FIG. 4 are vehicles equipped with a battery (secondary battery) such as an electric vehicle or a hybrid type vehicle using an internal combustion engine and an electric motor in combination. The vehicles 20a to 20c receive electric power wirelessly transmitted from the charging apparatus 11 via the power-receiving coil 14 and can be charged in a battery (secondary battery).

The pallet 15 is an onboard table that can be moved in a state that the vehicle is mounted. As the pallet 15, in addition to a rectangular shape as shown in FIGS. 3 and 4, various types of pallets such as a pallet that supports only a wheel portion can be used. Also, as another vehicle moving part, it is also possible to use a palletless system for delivering a vehicle by using a comb type arm instead of the pallet.

Next, the operation of the present exemplary embodiment will be described in detail with reference to the drawings. It is described on the premise that three vehicles 20a to 20c parked in a stuffing manner according to the reference line 13 as shown in FIG. 4 from the state shown in FIG. 3.

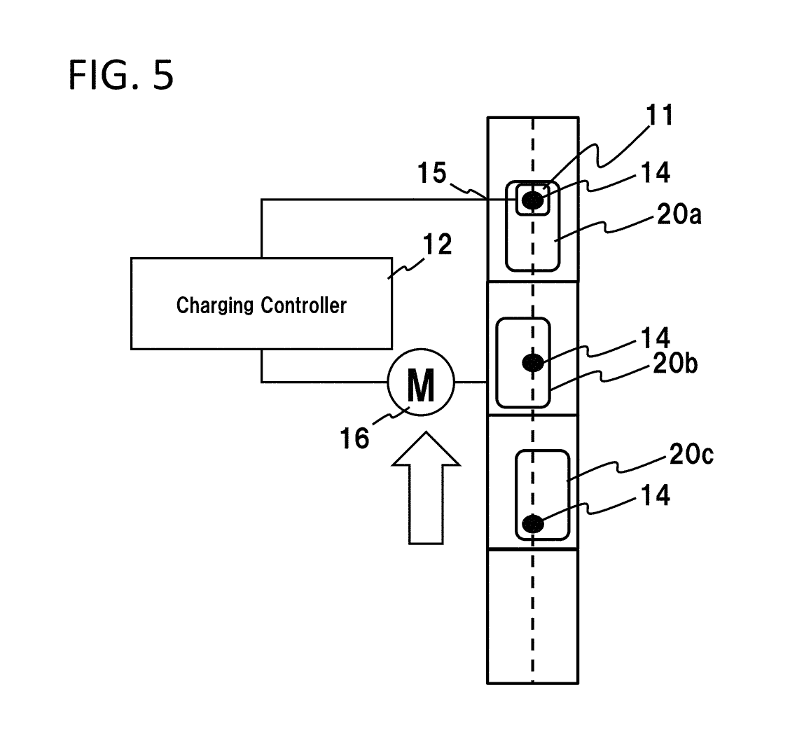

When the three vehicles 20a to 20c enter the loading and a predetermined charging start condition is satisfied, the charging controller 12 drives the pallet moving part 16 and as shown in FIG. 5, firstly the vehicle 20a is moved directly above the charging apparatus 11. At this time, the vehicle 20a is parked according to the reference line 13 so that the power-receiving coil 14 is placed directly above the charging apparatus 11. Therefore, the charging controller 12 can start charging immediately by merely moving the pallet on which the vehicle 20a is mounted to a fixed position (However, it is the position where the power-receiving coil 14 and the power-transmitting coil of the charging apparatus 11 face each other and is different for each vehicle). In the example of FIG. 5, although the charging controller 12 moves with the vehicles 20b and 20c at the same time, the vehicles 20b and 20c may not be moved at the same time. Hereinafter, “moving to a fixed position” is not limited to the case of sequentially moving the three vehicles 20a to 20c parked in the vertical direction as shown in FIGS. 4 and 5, and it also includes a case where a pallet loading no vehicle exists. That is, the “moving to a fixed position” part moving so that the relative position between the vehicle and the charging apparatus is changed along the first direction (a top-bottom direction of FIG. 3) in which a plurality of sections is arranged.

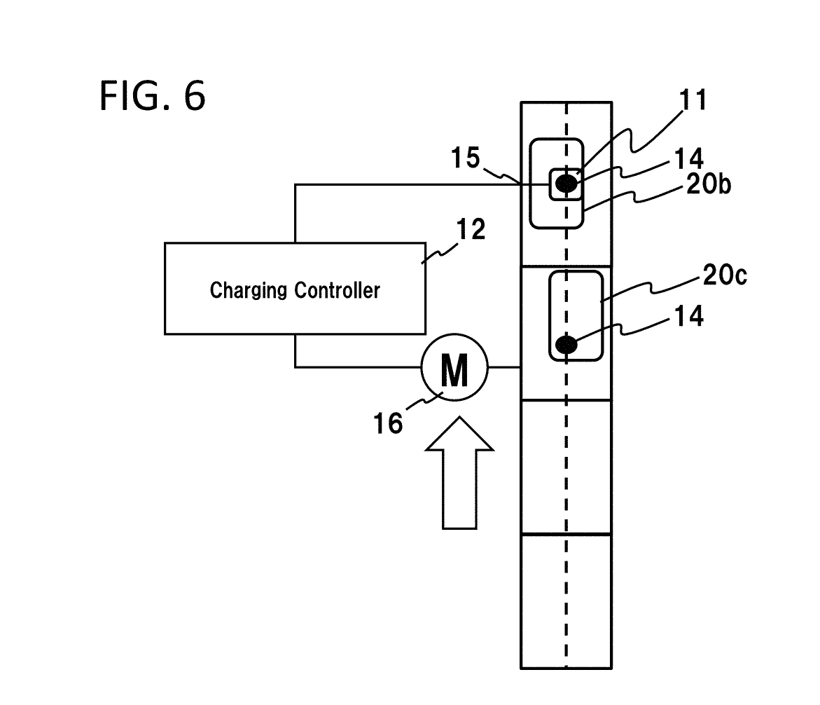

Thereafter, when the charging of the vehicle 20a is completed, the vehicle 20a can go outside. When the vehicle 20a goes outside, the charging controller 12 drives the pallet moving part 16 to move the vehicle 20b directly above the charging apparatus 11 as shown in FIG. 6. Here the charging controller 12 can start charging immediately by merely moving the pallet on which the vehicle 20b is mounted to a fixed position since the vehicle 20b is parked according to the reference line 13 so that the power-receiving coil 14 is placed directly above the charging apparatus 11. In the example of FIG. 6, although the charging controller 12 moves the vehicle 20c, too, at the same time, the vehicle 20c may not be moved.

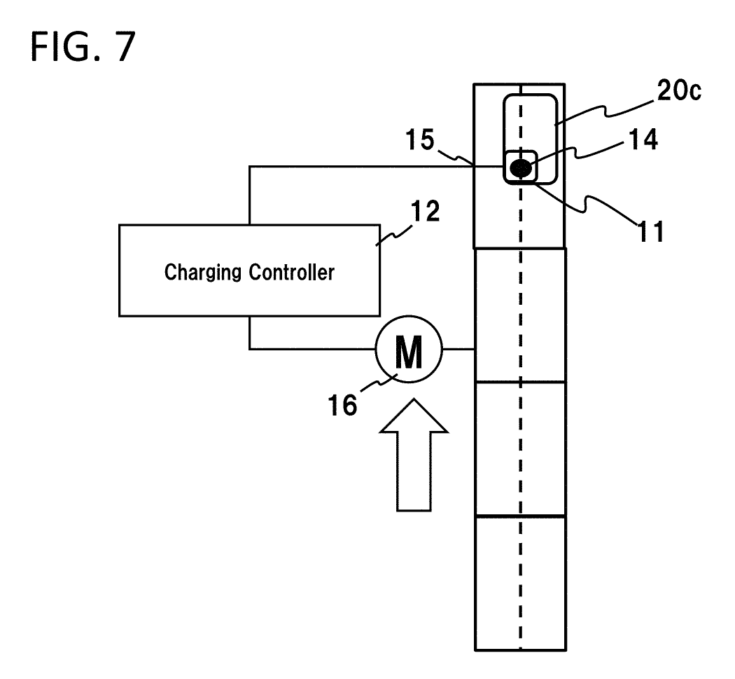

Thereafter, when the charging of the vehicle 20b is completed, the vehicle 20b can go outside. When the vehicle 20b goes outside, the charging controller 12 drives the pallet moving part 16 to move the vehicle 20c just above the charging apparatus 11 as shown in FIG. 7. Here the charging controller 12 can start charging immediately by merely moving the pallet on which the vehicle 20c is mounted to the fixed position since the vehicle 20c is parked according to the reference line 13 so that the power-receiving coil 14 is placed directly above the charging apparatus 11.

Thereafter, when charging of the vehicle 20c is completed, the vehicle 20c can go outside. As described above, according to the present exemplary embodiment, it is possible to align the charging apparatus 11 and the power-receiving coil 14 by moving the vehicle. That is, charging can be performed by merely setting the vehicle at the fixed position without adjusting the position in front-rear direction of the vehicle, it is possible to efficiently charge a plurality of vehicles. The reason is that each vehicle aligns to the reference line 13, so it is sufficient merely to move the charging apparatus 11 and the pallet 15 in the vertical direction to the one direction. That is, when aligning with the power-receiving coil of the vehicle, it is sufficient merely to move the charging apparatus or the pallet in a single direction, and the moving means and the moving mechanism can be simplified (not complicated). This point is also advantageous from the viewpoint of energy saving.

For example, in comparison with Patent Literature 2, the configuration of Patent Literature 2 needed to move in the X-Y axes directions, and complicated mechanisms and means were necessary. However, in the present disclosure, since the vehicle (driver) aligns in one direction, it can be aligned by moving the charging apparatus or the pallet only in a direction orthogonal to the one direction (on the same horizontal plane). In other words, in the present exemplary embodiment, there may be a mechanism for moving the charging apparatus in the first direction (the top-bottom direction in FIGS. 3 to 6) in which the sections (or vehicles) are arranged.

The reason is that since for aligning in the direction orthogonal to the first direction, the driver moves based on the reference line 13, compared with Patent Literature 2, the present disclosure can align the charging apparatus and the vehicles by a simple mechanism.

The vehicle charging system of the present exemplary embodiment as described above can be suitably applied as a charging station that charges during a parking period of a fixed time. Also, the vehicle charging system of the present exemplary embodiment can be applied not only to a charging station but also as a built-in vehicle charging system in a mechanical type parking lot apparatus installed in entertainment facilities, the market or the like.

In the above example, although charging is performed in the order of the vehicles 20a, 20b, and 20c, for example, when it is determined that charging of the vehicle 20b is unnecessary, the vehicle 20b is skipped and the vehicle 20c may be charged next to vehicle 20a.

### Second Exemplary Embodiment

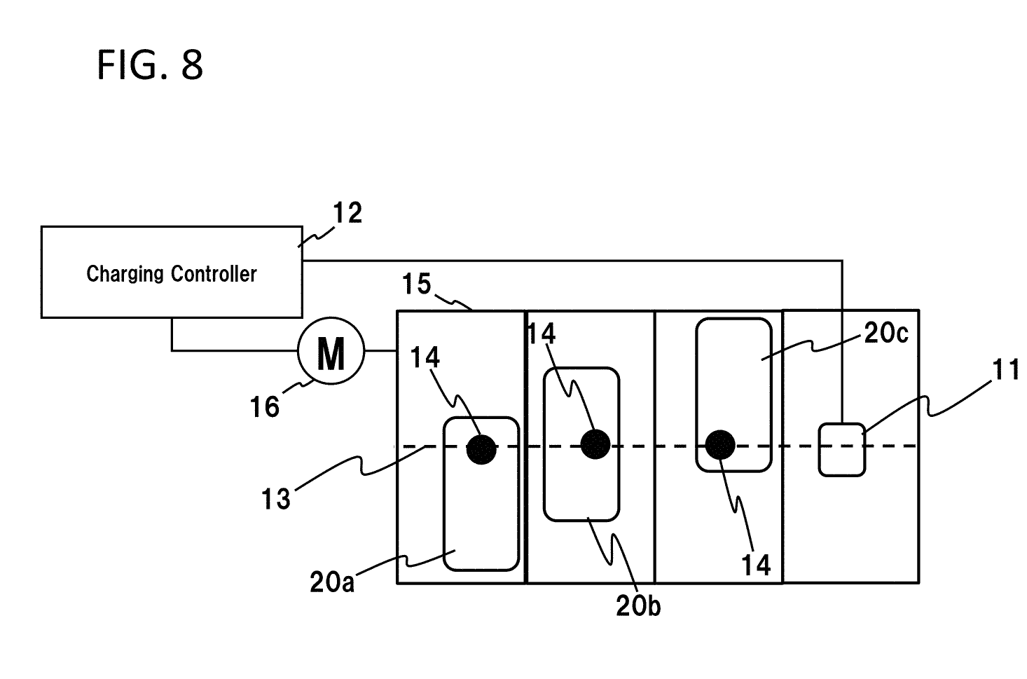

Next, a second exemplary embodiment in which the feed direction of the vehicle is changed not to the vehicle traveling direction but to the lateral direction to the vehicle traveling direction will be described in detail with reference to drawings. FIG. 8 is a diagram showing a configuration of a vehicle charging system according to a second exemplary embodiment of the present disclosure. Referring to FIG. 8, there is shown a configuration in which the charging apparatus 11 is placed under the pallet 15 and the charging controller 12 are connected. Except that the parking direction of the vehicle and the feeding direction accompanying the parking direction of the vehicle are changed, they are the same as the first exemplary embodiment, so the differences will be mainly explained below.

In the present exemplary embodiment, the reference line 13 is arranged in a direction extending laterally to the vehicle traveling direction. A broken line extending in the left-right direction (first direction) of FIG. 8 is a reference line 13 for parking guidance shown to the driver of the vehicles 20a to 20c. While viewing the reference line 13, the drivers of the vehicles 20a to 20c park so that the power-receiving coil of the vehicle is positioned on the reference line 13. By doing so, it is possible to configure a train of vehicles so that the power-receiving coils of the vehicles 20a to 20c and the power-transmitting coil of the charging apparatus 11 are aligned in one straight line by merely moving the pallet 15.

Next, the operation of the present exemplary embodiment will be described. In the initial state, as shown in FIG. 8, it will be described on the premise that three vehicles 20a to 20c are parked in parallel according to the reference line 13.

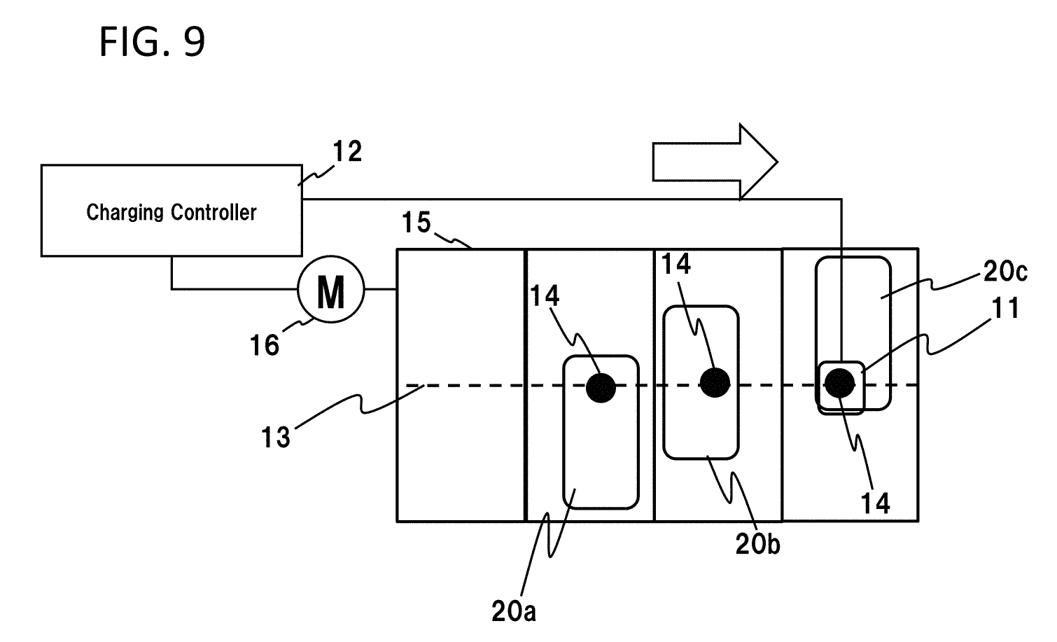

When a predetermined charging start condition is satisfied, the charging controller 12 drives the pallet moving part 16 as shown in FIG. 9, first, the vehicle 20c is moved directly above the charging apparatus 11. At this time, the vehicle 20c is parked according to the reference line 13 so that the power-receiving coil 14 is placed directly above the charging apparatus 11. Therefore, the charging controller 12 can start charging immediately by merely moving the pallet on which the vehicle 20c is mounted to a fixed position. In the example of FIG. 9, although the charging controller 12 moves the vehicles 20b and 20a simultaneously, it is not necessary to simultaneously move the vehicles 20b and 20a.

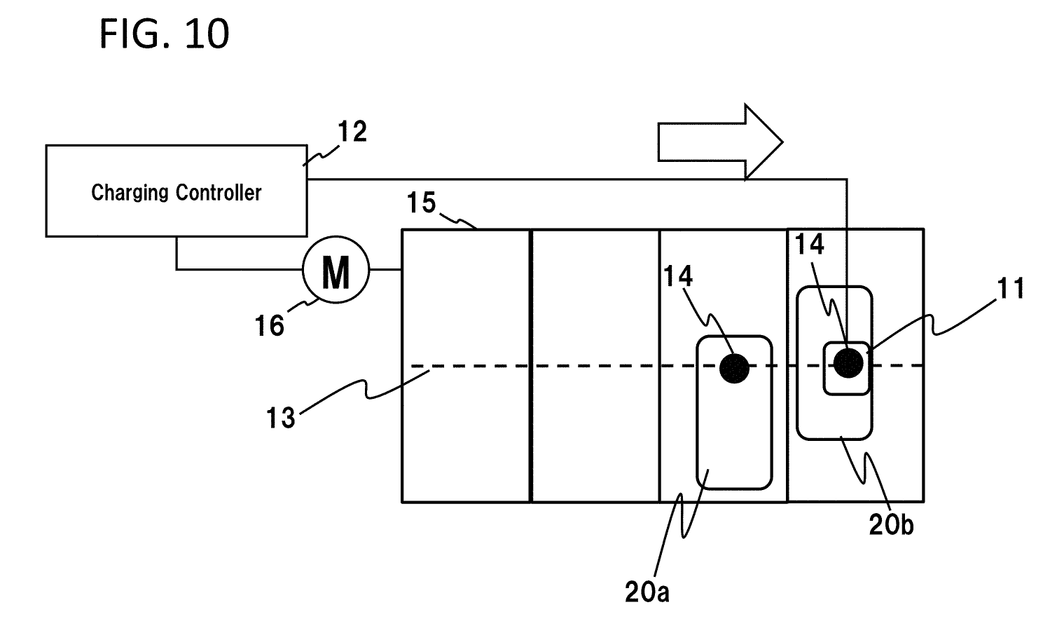

Thereafter, when charging of the vehicle 20c is completed, the vehicle 20c can go outside. When the vehicle 20c goes outside, the charging controller 12 drives the pallet moving part 16 as shown in FIG. 10 to move the vehicle 20b just above the charging apparatus 11. Here the charging controller 12 can start charging immediately by merely moving the pallet on which the vehicle 20b is mounted to a fixed position since the vehicle 20b is parked according to the reference line 13 so that the power-receiving coil 14 is placed directly above the charging apparatus 11. In the example of FIG. 10, although the charging controller 12 moves the vehicle 20a at the same time, the vehicle 20a may not be moved at the same time.

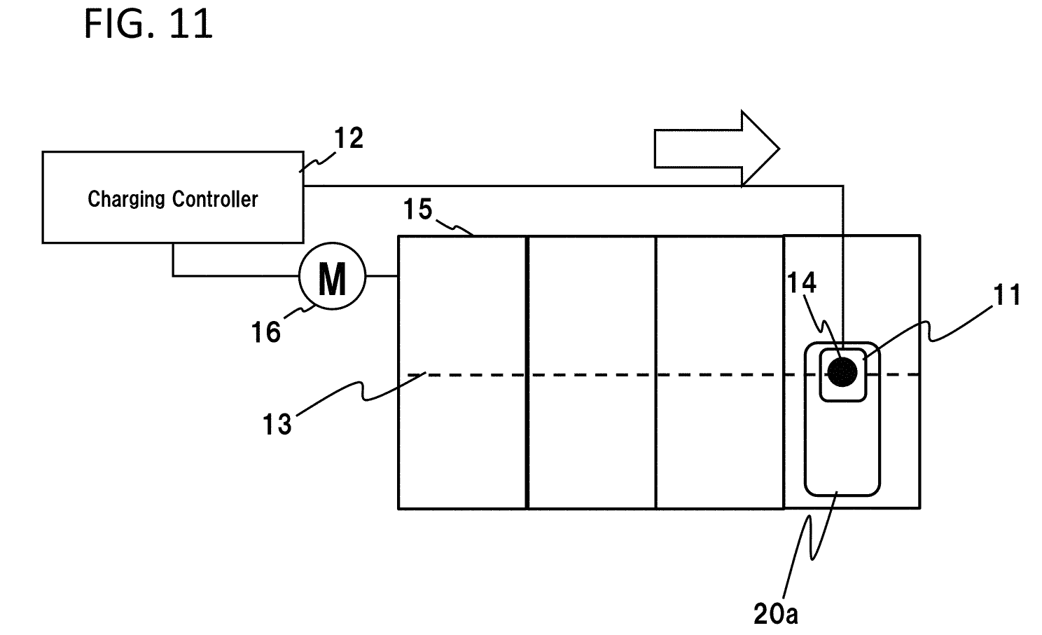

Thereafter, when the charging of the vehicle 20b is completed, the vehicle 20b can go outside. When the vehicle 20b goes outside, the charging controller 12 drives the pallet moving part 16 as shown in FIG. 11 to move the vehicle 20a just above the charging apparatus 11. Here the charging controller 12 can start charging immediately by merely moving the pallet on which the vehicle 20a is mounted to a fixed position since the vehicle 20a is parked according to the reference line 13 so that the power-receiving coil 14 is placed directly above the charging apparatus 11. “Moving to a fixed position” is not limited to the case of sequentially moving the three vehicles 20a to 20c parked side by side as shown in FIG. 9, and it also includes a case where there is a pallet(s) on which no vehicle is mounted. That is, a “moving to a fixed position” part moving so that the relative position between the vehicle and the charging apparatus is changed along the first direction (right-left direction of FIG. 9) in which a plurality of sections is arranged.

Thereafter, when the charging of the vehicle 20a is completed, the vehicle 20a can go outside. As described above, according to the present exemplary embodiment, it is possible to align the charging apparatus 11 and the power-receiving coil 14 by moving the vehicle. That is, without performing the position adjustment in front-rear direction of the vehicle, charging can be performed by merely setting the vehicle at a fixed position, so it is possible to efficiently charge a plurality of vehicles.

The advantage of the second exemplary embodiment in comparison with the first exemplary embodiment resides in that the order of going outside can freely be changed as it is not stuffy type parking. For example, the vehicle 20b or the vehicle 20a may be first charged. Also, the charging order may be determined according to a predetermined charging policy. For example, it may prioritize the charging of vehicles that arrived earliest, and it also can prioritize the charging of vehicles that are expected that time going outside is the earliest based on the state of payment of the parking fee and the position information and behavior information of the driver. Also, In the second exemplary embodiment, since the direction of alignment to the reference line 13 is consistent with the vehicle traveling direction, it is possible to align the vehicle and the reference line in forward or reverse direction, and it is easy to perform fine adjustment thereof. Also, in the second exemplary embodiment, since the direction orthogonal to the first direction (the direction of the reference line 13 of FIG. 8) is the same as the driving direction of the vehicle, the driver can easily perform alignment of the vehicle and the reference line.

### Third Exemplary Embodiment

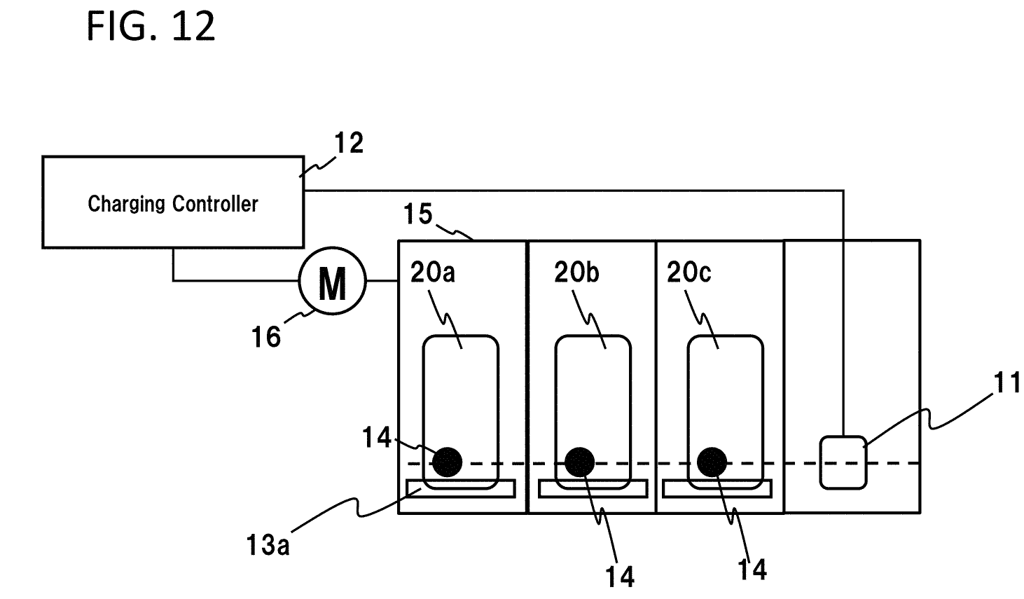

Next, a third exemplary embodiment in which the parking position is instructed to the driver by using a stopper as a restricting part configured to restrict the movement of the wheel(s) instead of the reference line 13 of the second exemplary embodiment, will be described. FIG. 12 is a diagram showing a configuration of a vehicle charging system according to the third exemplary embodiment of the present disclosure. The difference from the second exemplary embodiment shown in FIG. 8 resides in that a wheel stop 13a is installed instead of the reference line. By each of the drivers parking the vehicle in a state where the wheel and the stopper 13a are in contact with each other, a vehicle train can be configured so that the power-receiving coils 14 of the vehicles 20a to 20c and the power-transmitting coil of the charging apparatus 11 are arranged in one straight line (see broken lines).

Hereinafter, the operations of the present exemplary embodiment are the same as those of the second exemplary embodiment, so the explanation is omitted. According to the present exemplary embodiment, compared to the first and second exemplary embodiments, there is an advantage to set a release from the troublesomeness parking while viewing the reference line 13. Also, as apparent from the comparison between FIG. 8 and FIG. 12, the present exemplary embodiment can be suitably applied to a case where the position of the power-receiving coil in the vehicle is determined at a fixed position. A configuration suitable for a case where the position of the power-receiving coil in the vehicle is not determined will be described in the following fourth exemplary embodiment.

In the above-described exemplary embodiment, although there are described using the wheel stopper 13a as a regulating part configured to regulate the movement of the wheel(s), a similar effect can be obtained by forming a bump (raised portion) or a dip (recessed portion) instead of the wheel stopper 13a.

### Fourth Exemplary Embodiment

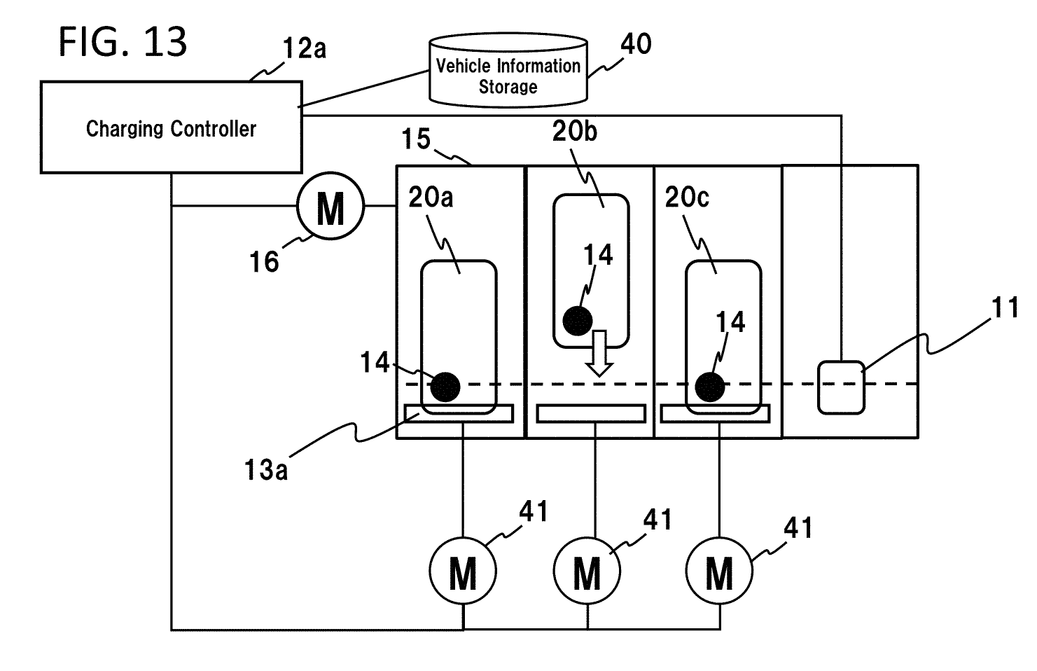

Next, a fourth exemplary embodiment in which the wheel stopper 13a of the third exemplary embodiment can be adjusted according to the position of the power-receiving coil of the vehicle will be described. FIG. 13 is a diagram showing a configuration of a vehicle charging system according to the fourth exemplary embodiment of the present disclosure. The difference from the third exemplary embodiment shown in FIG. 12 resides in that the vehicle information storage 40 is connected to the charging controller 12a, and the wheel stopper 13a can be moved using the wheel stopper moving part 41 based on a piece of information read out from the vehicle information storage 40 by the charging controller 12a and an item of information for specifying vehicle type input from an external apparatus. Since other configurations are the same as those of the third exemplary embodiment, the differences will be mainly described below.

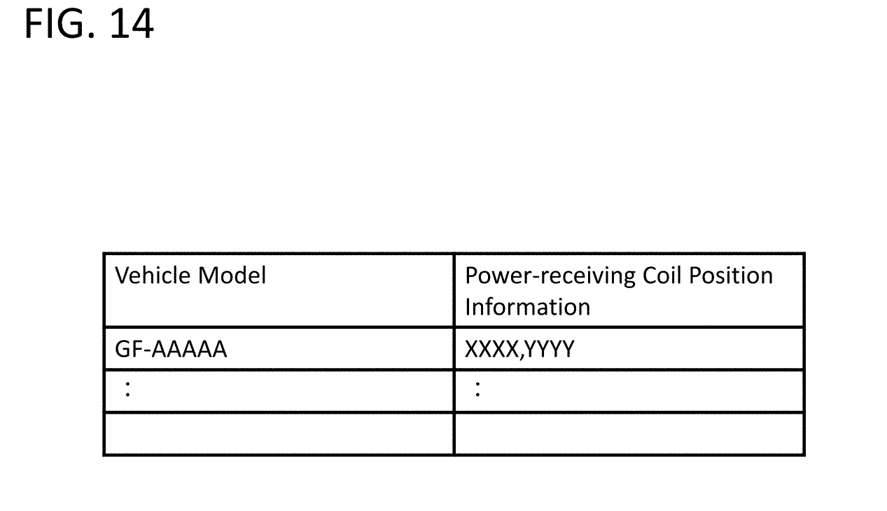

FIG. 14 is a diagram showing an example of the vehicle information stored in the vehicle information storage 40. In the example of FIG. 14, the position of the power-receiving coil is registered for each vehicle type information. As the vehicle type information, it is possible to use type or model number information indicated in the car inspection certificate and a selling code used by manufacturers or dealers.

The charging controller 12a drives the wheel stopper moving part 41 to move the wheel stop 13a based on the information read out from the vehicle information storage portion 40 and the information for specifying the vehicle type input from the external apparatus. As the information for specifying the vehicle type or model, for example, a vehicle image captured by a camera at an entrance of a parking lot, vehicle type or model information received from the vehicle, or the like can be used. Also, when a vehicle type or model can be obtained from a vehicle number, ETC (Electronic Toll Collection System) information, or the like via a network, a configuration that acquires the vehicle number and ETC information to inquire the network side to obtain vehicle type or model information, can also be adopted.

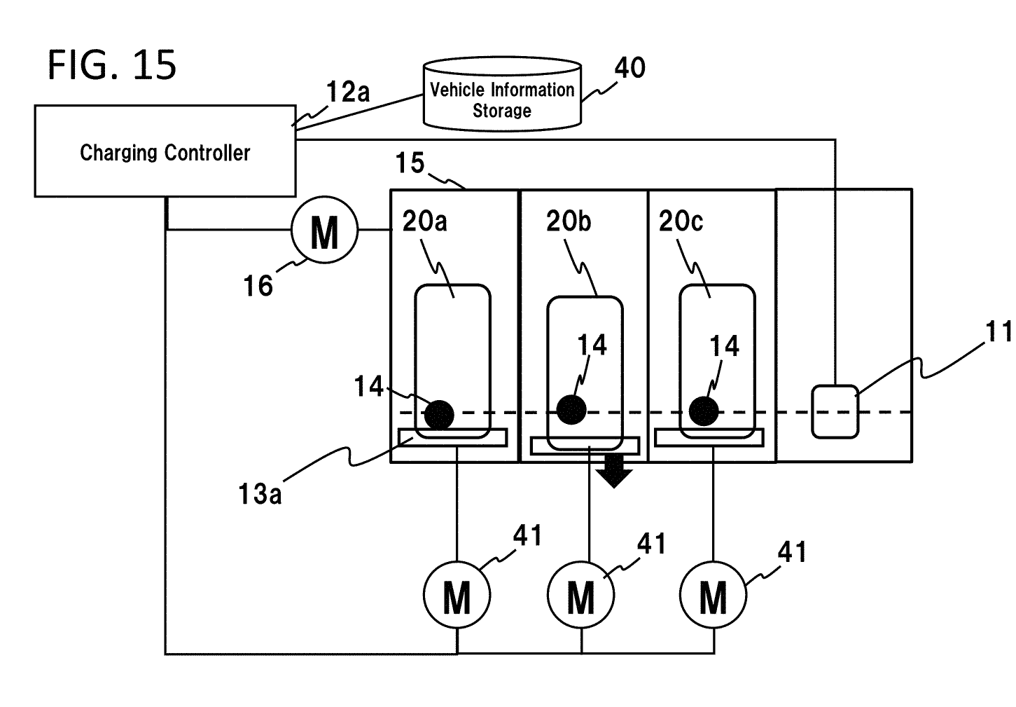

Next, the operation of the present exemplary embodiment will be described. For example, as shown in FIG. 15, it will be described on the premise that the vehicle 20b has entered between the vehicles 20a and 20c and parked. In this case, the charging controller 12a reads out the position information of the power-receiving coil of the vehicle 20b from the vehicle information storage 40 to move the wheel stop 13a to an appropriate position as shown in FIG. 15 (see the black arrow line).

Hereinafter, since the operations of the present exemplary embodiment are the same as those of the second exemplary embodiment, the description is omitted. According to the present exemplary embodiment, compared to the third exemplary embodiment, there is an advantage that it is possible to apply to various vehicles with different positions of power-receiving coil.

The timing to move the wheel stop 13a may be either when the parking space of the vehicle 20b is determined or when the vehicle 20b enters the parking space. In the latter case, it can be realized by configuring so that entering the parking space of the vehicle 20b can be detected by installing a camera or a sensor in the parking space.

Also, in the above-described fourth exemplary embodiment, although it is described that the wheel stopper 13a is moved, for example, in the first and second exemplary embodiments, it can also be applied to a configure that the reference line 13 configured by laser light or the like is moved according to the position of the power-receiving coil 14 per vehicle type or model.

Also, in the above-described fourth exemplary embodiment, although it is described that the position information of the power-receiving coil is registered in the vehicle information storage 40, instead of the position information of the power-receiving coil, the stop position by vehicle types, the position of the wheel stopper, or the like may be registered.

Also, in the above-described fourth exemplary embodiment, although it is described as a configure that the position information of the power-receiving coil is obtained using the vehicle type or model as a clue, it is conceivable that the position information of the power-receiving coil, the position information of the stop position and the wheel stopper, or the like is obtained from the external apparatus such as the vehicle information server or the like, the vehicle number, the ETC information or the like via the network. In this case, the charging controller 12a acquires the vehicle number or the ETC information and inquires the network side to acquire information for changing the position of the reference line 13, the wheel stopper 13a, or the like. Likewise, when a storage device for storing position information of the power-receiving coil and a communication device capable of communicating with the charging controller 12a are provided in the vehicle body, it is also conceivable to acquire information for changing the positions of the reference line 13, the wheel stopper 13a, or the like from these vehicles.

In either case, the charging controller 12a changes the position of the reference line 13, the car stop 13a, or the like for each vehicle based on the information acquired from these devices or the vehicle.

Also, when the position information of the power-receiving coil is different for each vehicle, in addition to the above-described vehicle type or model information, information for specifying the position of the other power-receiving coil is registered in the vehicle information storage 40, and the position of the power-receiving coil may be adjusted by reading data applied to these from the vehicle information storage 40.

### Fifth Exemplary Embodiment

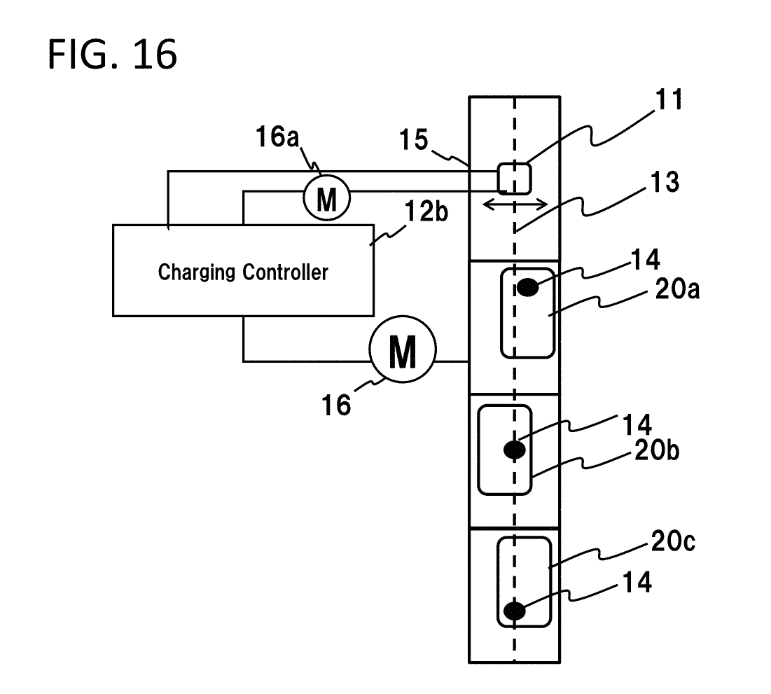

Next, a fifth exemplary embodiment in which guide of the stop position such as the reference line 13 can be omitted, will be described. FIG. 16 is a diagram showing a configuration of a vehicle charging system according to a fifth exemplary embodiment of the present disclosure. The difference from the first exemplary embodiment shown in FIG. 3 resides in the position control part 16a of the charging apparatus 11 is connected to the charging controller 12b, and the charging controller 12b can adjust the position of the charging apparatus 11. Since other configurations are the same as those of the first exemplary embodiment, the differences will be mainly described below.

The position adjusting part 16a is configured of a motor or the like, and is an adjusting part configured to adjust the position of the charging apparatus 11. Although the direction of the position adjustment is preferably a direction orthogonal to a virtual reference line 13 (which may be non-displayed) on the horizontal plane, that is, a lateral direction to the vehicle traveling direction in FIG. 16, it may be possible to make fine adjustments also in other directions.

Regarding the positioning of the charging apparatus 11 and the power-receiving coil 14 of the vehicle, a method of bringing the power-transmitting coil and the power-receiving coil 14 close to each other to detect a point where the current flowing to the power-transmitting side coil is minimized, or a method of detecting a voltage of the power-receiving coil 14 is the largest, can be used. Also, as the fourth exemplary embodiment, it is also possible to adopt a method of providing the vehicle information storage 40 and driving the position adjustment unit 16a based on the position information of the power-receiving coil read out from the vehicle information storage 40.

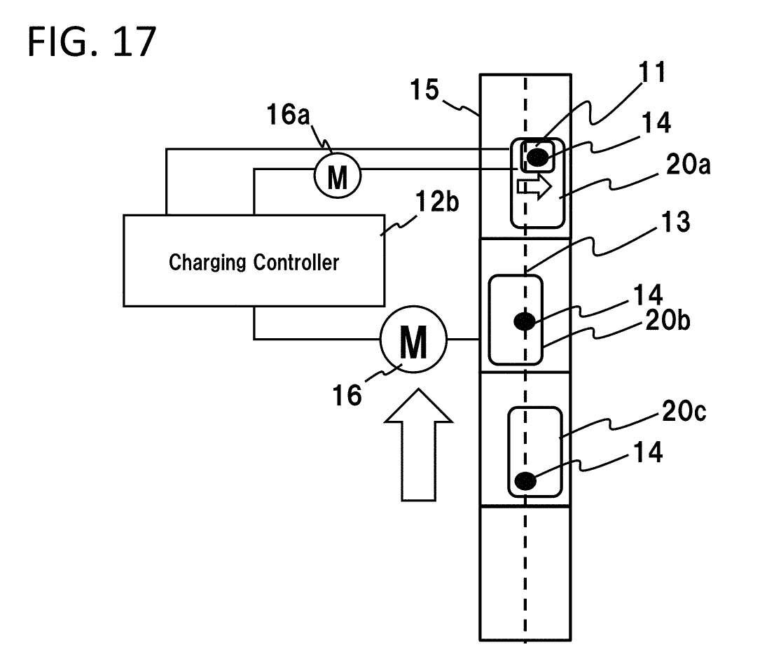

Next, the operation of the present exemplary embodiment will be described. For example, as shown in FIG. 17, it will be described on the premise that the vehicle 20a is parked in a state deviated to the right from the virtual reference line 13. In this case, the charging controller 12b drives the position adjusting part 16a to move the charging apparatus 11 to the right, and controls so that the power-receiving coil 14 of the vehicle 20a faces the charging apparatus 11.

Hereinafter, since the operations of the present exemplary embodiment are the same as those of the first exemplary embodiment, the explanation is omitted.

According to the present exemplary embodiment, compared to the first exemplary embodiment, there is an advantage that it can be charged even if parked in a state deviated from the virtual reference line 13. Also, in the present exemplary embodiment, it is also possible to reduce troublesomeness of parking while viewing the reference line 13.

### Sixth Exemplary Embodiment

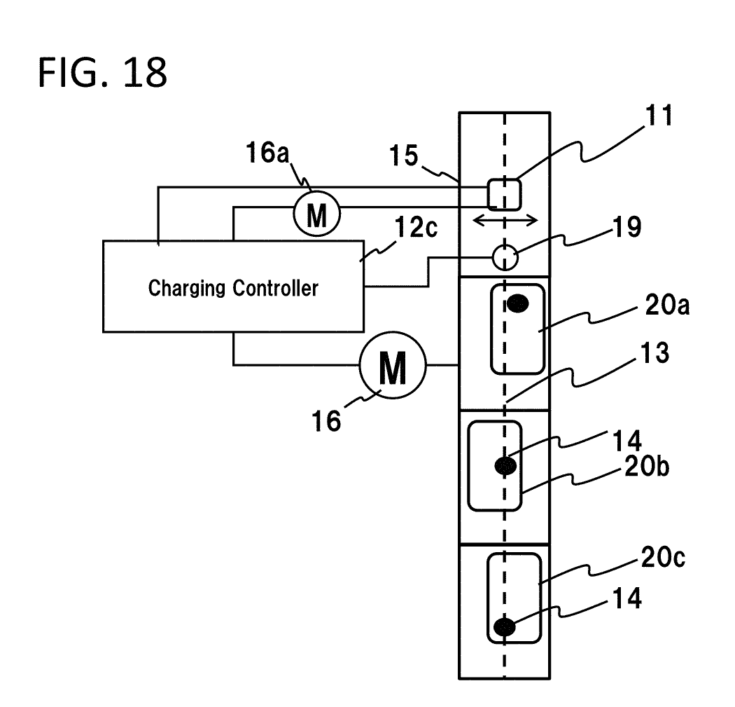

Next, a sixth exemplary embodiment in which a deviation can be detected earlier than the virtual reference line 13 relative to the fifth exemplary embodiment, will be described. FIG. 18 is a diagram showing a configuration of a vehicle charging system according to the sixth exemplary embodiment of the present disclosure. The difference from the fifth exemplary embodiment shown in FIG. 16 is that a deviation amount detecting part 19 is added to the charging controller 12c. Since the other configurations are the same as those of the fifth exemplary embodiment, the differences will be mainly described below.

The deviation amount detecting part 19 is configured by, for example, a sensor or a camera for measuring the position of the power-receiving coil (charge port), and measures the deviation amount of the power-receiving coil (charge port) to the virtual reference line 13. The deviation amount of the power-receiving coil (charging port) to the virtual reference line 13 measured by the deviation amount detecting part 19, is transmitted to the charging controller 12c.

The charging controller 12c drives the position adjusting part 16a based on the deviation amount of the power-receiving coil (charging port) to the virtual reference line 13. For example, as shown in FIG. 18, when the power-receiving coil (charging port) of the vehicle 20a is deviated to the right from the virtual reference line 13, the charging controller 12c drives the position adjusting part 16a to move the charging apparatus 11 to the right side and controls so that the power-receiving coil 14 of the vehicle 20a faces (i.e., registers with) the charging apparatus 11.

Hereinafter, since the operations of the present exemplary embodiment are the same as those of the first exemplary embodiment, the explanation is omitted. According to the present exemplary embodiment, in addition to the effects of the fifth exemplary embodiment, since the positional deviation of the charging apparatus 11 can be corrected at an early stage, there is an effect that the charging cycle can be shortened.

### Seventh Exemplary Embodiment

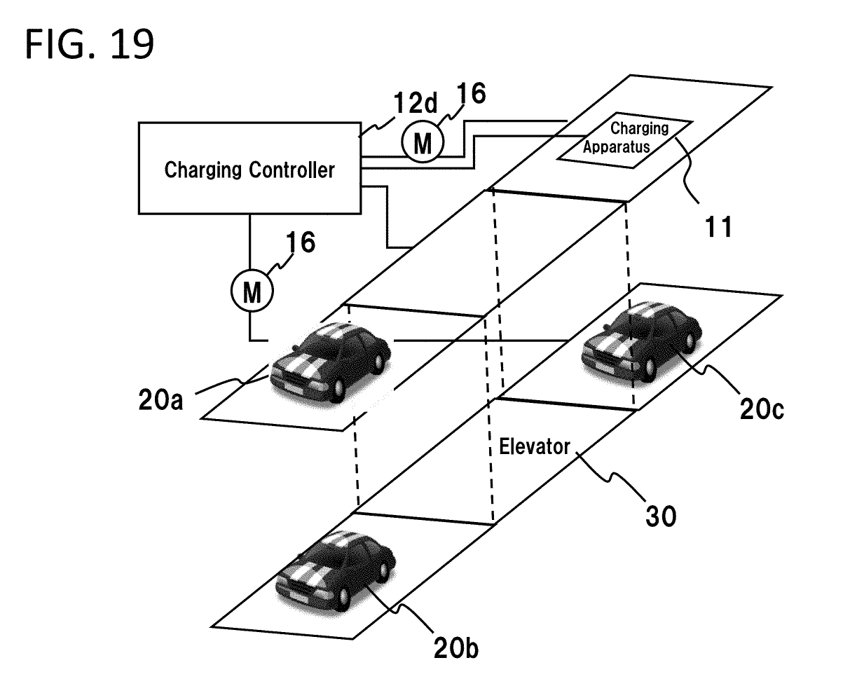

Next, a seventh exemplary embodiment in which the configuration of the first exemplary embodiment is applied to a mechanical three-dimensional parking lot, will be described. FIG. 19 is a diagram showing a configuration of a parking lot system according to a seventh exemplary embodiment of the present disclosure. The difference from the configuration shown in FIG. 3 is that an elevating machine (elevator) 30 is added so that vehicles can be accommodated in a plurality of stages.

In addition to the control of the elevating machine (elevator) 30, the basic operations are the same as the first exemplary embodiment. For example, it will be described based on the premise that the charging apparatus 11 and the vehicle 20a are accommodated on the second floor and the vehicles 20b and 20c are accommodated on the first floor. When charging the vehicle 20a, the charging controller 12d drives the pallet moving part 16 to move the vehicle 20a to make the power-receiving coil of the vehicle 20a face the power-transmitting coil of the charging apparatus 11 to charge.

For example, when charging of the vehicle 20b on the first floor is intended, the charging controller 12d drives the pallet moving part 16 to load the vehicle 20b on the elevator 30 and then, the vehicle 20b is moved to the second floor by the elevator 30. Then, the charging controller 12d drives the pallet moving part 16 to move the vehicle 20b to make the power-receiving coil of the vehicle 20b face the power-transmitting coil of the charging apparatus 11 to charge. Of course, after completion of charging, the process for returning the charged vehicle 20b to the first floor may be performed.

As described above, the present disclosure can be applied to a multistory parking lot without problems. Of course, also in the seventh exemplary embodiment, the position adjusting function of the charging apparatus 11 as the fifth and sixth exemplary embodiments, can be added. Also, as described in the fifth and sixth exemplary embodiments, by providing the vehicle information storage 40, when adjusting the position of the charging apparatus 11, the position adjustment corresponding to the vehicle type or model can be performed.

### Eighth Exemplary Embodiment

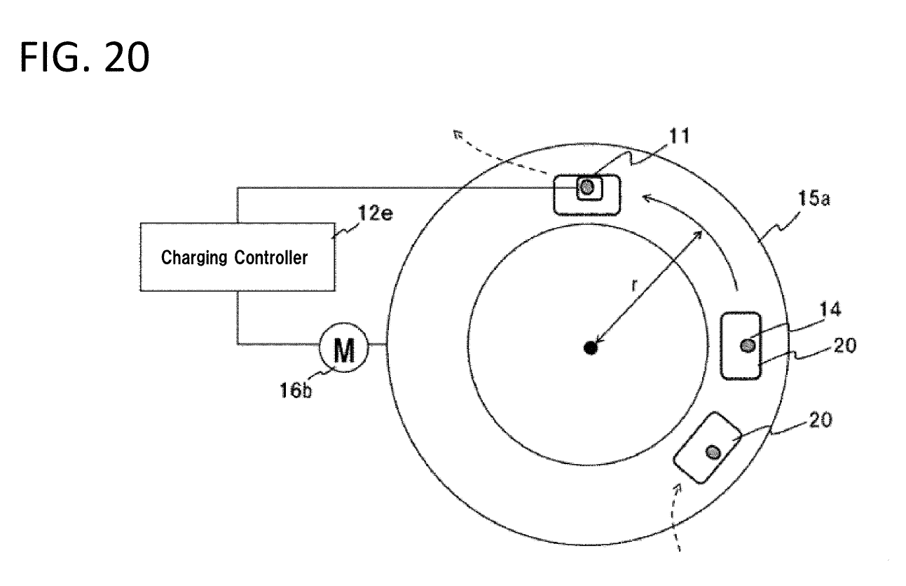

In the first to seventh exemplary embodiments described above, although it is described on the premise that the charging apparatus or the vehicle moves linearly, by moving (circulating) the charging apparatus or the vehicle around a certain point, method for making the power-receiving coil face the charging apparatus, can also be adopted. FIG. 20 is a diagram showing a configuration of a vehicle charging system according to an eighth exemplary embodiment of the present disclosure. In the example of FIG. 20, instead of the pallet, a turntable 15a capable of loading a plurality of vehicles, is used.

In the present exemplary embodiment, the charging apparatus 11 is placed at a position away from the center of the turntable 15a by a predetermined distance (i.e., radius) r. Then, the charging controller 12e is configured so that the turntable can be rotated using the rotating part 16b.

Other basic operations are the same as those of the first to seventh exemplary embodiments, and the charging controller 12e of the present exemplary embodiment changes the relative position between the vehicle and the charging apparatus 11 along the circular arc to a plurality of vehicles 20 stopped in a queue on the turn table 15a by turning the turntable 15a. Then, the charging controller 12e sequentially charges the power-receiving coil 14 of the vehicle facing the charging apparatus 11.

As a method of changing the relative position between the vehicle and the charging apparatus, it is possible to adopt a method of placing the charging apparatus 11 on the turntable 15a and rotating the charging apparatus 11 other than the method of turning the vehicle-turntable 15a.

Also, in the present exemplary embodiment, as the first exemplary embodiment, the reference line 13 may be shown, or as the fifth and sixth exemplary embodiments, an alignment mechanism in a radial direction of the turntable 15a may be provided on the charging apparatus 11 side. In the example of FIG. 20, although it may be configured to make one rotation using the circular turntable 15a, instead of the turntable, it is possible to obtain a configuration that can make the charger 11 face the power receiving coil 14 by using a fan-shaped (or arc-shaped) onboard stand, that moves in a reciprocating motion.

Although the effect of the present exemplary embodiment is the same as that of the first to seventh exemplary embodiments, as shown by the arrow (broken line) in FIG. 20, there is the advantages that it is easy to put in and take out the vehicle and the degree of freedom of the installation place is increased.

The functions of the charging controller used in each of the above-described exemplary embodiments can also be realized by a computer program that executes each of the above-described processes using the hardware to a computer configuring the charging controller.

Although the exemplary embodiments of the present invention have been described hereinabove, the present invention is not limited to the above-described exemplary embodiments, and further modifications, substitutions, and adjustments can be added in a range that does not deviate from the basic technical concept of the present invention. For example, the network configuration(s), the configuration of each element, and the expression form of a message shown in each drawing are examples for facilitating understanding of the present invention, and are not limited to the configurations shown in these drawings.

Finally, the preferred modes of the present invention are summarized.

### [First Mode]

(Refer to the vehicle charging system according to the first aspect)

### [Second Mode]

The following configuration can be adopted.
In the vehicle charging system described above,
further, comprising a vehicle moving part confiture to move moving the vehicle(s),
wherein the charging controller changes the relative position between the vehicle and the charging apparatus by controlling the vehicle moving part to sequentially charge a plurality of vehicles that are stopping at a plurality of sections aligned in the first direction.

### [Third Mode]

The following configuration can be adopted.
In the vehicle charging system described above,
as the vehicle moving part,
a plurality of pallets arranged along the first direction, the pallet loading at least one vehicle; and
a pallet moving part configured to move the pallet in the first direction.

### [Fourth Mode]

The following configuration can be adopted.
In the vehicle charging system described above,
comprising a guiding part to configured to guide a driver of the vehicle,
a stop position on a straight line at which the power-receiving coil and the charging apparatus are capable of facing each other by moving the power-receiving coil.

### [Fifth Mode]

The following configuration can be adopted.
In the vehicle charging system described above,
further comprising a acquiring part configured to acquire information for changing a stop position for vehicle to vehicle from a predetermined external apparatus,
wherein the guiding part changes the stop position based on the information.

### [Sixth Mode]

The following configuration can be adopted.
In the vehicle charging system described above,
further comprising:
a specifying part configured to specify a type (or model)(generally represented as “type” herein) of the vehicle; and
a storing part configured to store position information of the power-receiving coil for each type of the vehicle,
wherein the guiding part the stop position along the first direction changes the stop position according to the specified type of the vehicle.

### [Seventh Mode]

The following configuration can be adopted.
In the vehicle charging system described above,
comprising a regulating part configured to regulate movement of a wheel(s) of the vehicle so that the vehicle stops at a stop position on a straight line at which the power-receiving coil and the charging apparatus face each other by moving any one of the power-receiving coil or the charging apparatus.

### [Eighth Mode]

The following configuration can be adopted.
In the vehicle charging system described above,
further comprising:
a specifying part configured to specify types of the vehicle; and
a storing part configured to store position information of the power-receiving coil for each type of the vehicle,
wherein the regulating part changes the stop position according to the specified type of the vehicle.

### [Ninth Mode]

The following configuration can be adopted.
In the vehicle charging system described above, further comprising a acquiring part configured to acquire information for changing a stop position for each vehicle from a predetermined external apparatus,
wherein the regulating part changes the stop position based on the information.

### [Tenth Mode]

The following configuration can be adopted.
In the vehicle charging system described above,
wherein the charging controller comprises a adjusting part configured to adjust a relative position between the vehicle and the charging apparatus in a direction different from the first direction.

### [Eleventh Mode]

The following configuration can be adopted.
In the vehicle charging system described above,
a non-contact type charging apparatus that performs charging of battery of a vehicle in a non-contact state by facing a power-receiving coil mounted on the vehicle;
a charging controller that sequentially charges a plurality of vehicles that are stopping aligned in a circular arc by changing a relative position between the vehicle and the charging apparatus along the circular arc to the plurality of vehicles that are stopping aligned in the circular arc in which the non-contact type charging apparatus is placed.

### [Twelfth Mode]

(Refer to the parking lot system according to the second aspect above)

### [Thirteenth Mode]

(Refer to the vehicle charging method according to the third aspect) Note, the twelfth to thirteenth modes can be developed (or extended) to the second to eleventh modes similarly to the first mode.

Note, each disclosure of the above patent literatures is incorporated by reference thereto in this application. Within the ambit of the entire disclosure (including claims) of the present invention, it is possible to change or adjust the exemplary embodiment(s) or example(s) based on the basic technical concept. Also, various combinations or selections of various disclosed elements (including each element of each claim, each element of each exemplary embodiment or example, elements of each drawing, etc.) can be made within the ambit of the disclosure of the present invention. That is, it goes without saying that the present invention includes various variations and modifications that could be achieved by one skilled in the art according to the entire disclosure including claims, and technical concept. In particular, with respect to the numerical range(s) described in this application, it should be interpreted that, any numerical value(s) or subrange(s) included within the range(s) as being concretely described even if not mentioned explicitly.

1. A vehicle charging system, comprising:
a non-contact type charging apparatus that charges a battery of a vehicle in a non-contact state by facing a power-receiving coil mounted on the vehicle; and
a charging controller configured to sequentially perform charging of vehicles that are stopping aligned in a first direction by changing a relative position between the vehicle and the charging apparatus along the first direction to the vehicles that are stopping at any one of a plurality of sections aligned in the first direction.

2. The vehicle charging system according to claim 1, further comprising a vehicle moving part configured to move the vehicle(s),
wherein the charging controller changes the relative position between the vehicle and the charging apparatus by controlling the vehicle moving part to sequentially charge a plurality of vehicles that are stopping at a plurality of sections aligned in the first direction.

3. The vehicle charging system according to claim 2, comprising:
as the vehicle moving part,
a plurality of pallets arranged along the first direction, the pallet(s) and loading at least one vehicle; and
pallet moving part configured to move the pallet(s) in the first direction.

4. The vehicle charging system according to claim 1, further comprising a guiding part configured to guide to a driver of the vehicle, a stop position on a straight line at which the power-receiving coil and the charging apparatus are capable of facing each other by moving the power-receiving coil.

5. The vehicle charging system according to claim 4, further comprising an acquiring part configured to acquire information for changing a stop position for vehicle to vehicle from a predetermined external apparatus,
wherein the guiding part changes the stop position based on the information.

6. The vehicle charging system according to claim 4, further comprising:
a specifying part configured to specify a type of the vehicle; and
a storing part configured to store position information of the power-receiving coil for each type to type of the vehicle,
wherein the guiding part changes the stop position according to the specified type of the vehicle.

7. The vehicle charging system according to claim 1, further comprising a regulating part configured to regulate movement of a wheel(s) of the vehicle so that the vehicle stops at a stop position on a straight line at which the power-receiving coil and the charging apparatus face each other by moving any one of the power-receiving coil or the charging apparatus.

8. The vehicle charging system according to claim 7, further comprising:
a specifying part configured to specify a type of the vehicle; and
a storing part configured to store position information of the power-receiving coil for each type to type of the vehicle,
wherein the regulating part changes the stop position according to the specified type of the vehicle.

9. The vehicle charging system according to claim 7, further comprising an acquiring part configured to acquire information for changing a stop position for each vehicle to vehicle from a predetermined external apparatus,
wherein the regulating part changes the stop position based on the information.

10. The vehicle charging system according to claim 1, wherein the charging controller comprises an adjusting part configured to adjust a relative position between the vehicle and the charging apparatus in a direction different from the first direction.

11. A vehicle charging system, comprising:
a non-contact type charging apparatus that performs charging of battery of a vehicle in a non-contact state by facing a power-receiving coil mounted on the vehicle;
a charging controller configured to sequentially perform charging of a plurality of vehicles that are stopping aligned in a circular arc by changing a relative position between the vehicle and the charging apparatus along the circular arc, to the plurality of vehicles that are stopping aligned in the circular arc in which the non-contact type charging apparatus is placed.

12. (canceled)

13. A method for charging vehicle(s) comprising:
preparing a non-contact type charging apparatus that charges a battery of a vehicle(s) in a non-contact state by facing a power-receiving coil mounted on the vehicle and
a charging controller configured to charge a relative position between a non-contact type charging apparatus and the vehicle(s);
charging a first vehicle stopping at any one of a plurality of sections aligned in a first direction; and
facing a second vehicle, stopping at another one of the plurality of sections, and the charging apparatus each other by changing a relative position between the charging apparatus and the vehicle after charging the first vehicle, to perform charging to the second vehicle.

14. The vehicle charging system according to claim 2, further comprising a guiding part configured to guide to a driver of the vehicle, a stop position on a straight line at which the power-receiving coil and the charging apparatus are capable of facing each other by moving the power-receiving coil.

15. The vehicle charging system according to claim 3, further comprising a guiding part configured to guide to a driver of the vehicle, a stop position on a straight line at which the power-receiving coil and the charging apparatus are capable of facing each other by moving the power-receiving coil.

16. The vehicle charging system according to claim 2, further comprising a regulating part configured to regulate movement of a wheel(s) of the vehicle so that the vehicle stops at a stop position on a straight line at which the power-receiving coil and the charging apparatus face each other by moving any one of the power-receiving coil or the charging apparatus.

17. The vehicle charging system according to claim 3, further comprising a regulating part configured to regulate movement of a wheel(s) of the vehicle so that the vehicle stops at a stop position on a straight line at which the power-receiving coil and the charging apparatus face each other by moving any one of the power-receiving coil or the charging apparatus.

18. The vehicle charging system according to claim 2, wherein the charging controller comprises an adjusting part configured to adjust a relative position between the vehicle and the charging apparatus in a direction different from the first direction.

19. The vehicle charging system according to claim 3, wherein the charging controller comprises an adjusting part configured to adjust a relative position between the vehicle and the charging apparatus in a direction different from the first direction.

20. The vehicle charging system according to claim 4, wherein the charging controller comprises an adjusting part configured to adjust a relative position between the vehicle and the charging apparatus in a direction different from the first direction.

21. The vehicle charging system according to claim 5, wherein the charging controller comprises an adjusting part configured to adjust a relative position between the vehicle and the charging apparatus in a direction different from the first direction.
